(19) United States
(12) Patent Application Publication
(10) Pub. No.: US 2006/0191919 A1
(43) Pub. Date: Aug. 31, 2006

(54) Temperature-display non-electric heated utensil device

(76) Inventor: Shao Lin Cheu, Taipei (TW)

Correspondence Address: Shao Lin Cheu, 235 Chung - Ho, Box 8-24, Taipei, TW

(21) Appl. No.: 11/045,669

(22) Filed: Jan. 31, 2005

(51) Int. Cl. H05B 6/80

(52) U.S. Cl. 219/730

(57) ABSTRACT

A non-electric heated utensil device comprises a non-electric heat utensil body capable of receiving foods therein, in that user can eat the food in the utensil directly; a temperature sensor for measuring temperatures of the food in the non-electric heat utensil body or temperatures of the non-electric heat utensil body; a display device for displaying the temperatures from the temperature sensor; and a power supply. The non-electric heated utensil device may be beverage. The non-electric heat utensil body is one of a cup, a bowl, a bottle, a kettle, and a basin. Thereby a speech integrated circuit is installed in the display device for emitting a sound to inform the temperature value. Moreover, an alarm can be installed to the utensil to alert the user that the temperature is out of an acceptable range.

### FIELD OF THE INVENTION

The present invention relates to utensils, and in particular to a temperature-display non-electric heated utensil device; wherein the non-electric heated utensil device is capable of displaying temperature of the food containing therein or temperature of the non-electric heat utensil body itself.

### BACKGROUND OF THE INVENTION

In daily lift, it is very often that people need to know temperatures of foods in a container. In one famous case, a customer eats high temperature beverage in a cup so as to hurt the throat and tongue herself. Thereby the beverage provider is in force to pay a great solatium to the customer. Thus, currently, there are many cups being added with an alert to inform the user must take attention to the temperature of the food in the utensils. However the users cannot know the temperatures of the foods in the cups so he (or she) can not well decide whether the food is suitable to be eaten. Thereby the danger of hurting oral cavity is still existed in drinking.

Furthermore, in feeing food to babies, it is often that the temperature of the food is necessary to know for avoiding the food is too hot or too cold so as to hurt the babies. However the prior art bottles have no this design.

It is often that the sellers or buyers hope to know the temperature of the food, but conventional utensils have no this design. Thereby the seller must control the temperature by experience or by using another thermometer to measure the temperature. It is inaccurate to decide the temperature by experience, and in most cases, people does not carry thermometer any time.

In the prior art, some electric heating utensils are equipped devices to display temperatures of foods containing within the utensils, but no non-electric heat utensil body has the device to measure or display temperatures of foods containing therein.

### SUMMARY OF THE INVENTION

Accordingly, the primary object of the present invention is to provide a non-electric heated utensil device capable of displaying temperature value, wherein the non-electric heated utensil device is capable of displaying temperature of the food containing therein or temperature of the non-electric heat utensil body itself. Thus, the user can know the temperature of the food in the non-electric heat utensil body or the temperature of the non-electric heat utensil body itself. Thereby the user can adapt a proper action or to adjust the temperature of the food or the non-electric heat utensil body.

To achieve object, the present invention provides a non-electric heated utensil device, wherein a non-electric heated utensil device comprises a non-electric heat utensil body capable of receiving foods therein so that user can eat the food in the utensil directly; a temperature sensor for measuring temperatures of the food in the non-electric heat utensil body or temperatures of the non-electric heat utensil body; a display device for displaying the temperatures from the temperature sensor; and a power supply. The non-electric heated utensil device is beverage. The non-electric heat utensil body is one of a cup, a bowl, a bottle, a kettle, and a basin. Thereby a speech integrated circuit is installed in the display device for emitting a sound to inform the temperature value. Moreover, an alarm can be installed to the utensil to alert the user that the temperature is out of an acceptable range.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 shows one embodiment of the present invention, wherein a chemical testing paper is used as a temperature sensor of the present invention.

FIG. 3 shows another embodiment of the present invention, where the temperature sensor is a mercury thermometer.

FIG. 4 shows a further embodiment of the present invention, where a speech IC and a button are added to the present invention.

FIG. 5 shows the circuit arrangement of the present invention.

FIG. 6 shows one application of the present invention, wherein the present invention is used to a kettle.

FIG. 7 shows one embodiment of the present invention, where it is illustrated that the display device is installed on a cover.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

In the drawings, a cup is used as an example, however the present invention is not confined to the cup, other utensil is also within the scope and spirit of the present invention.

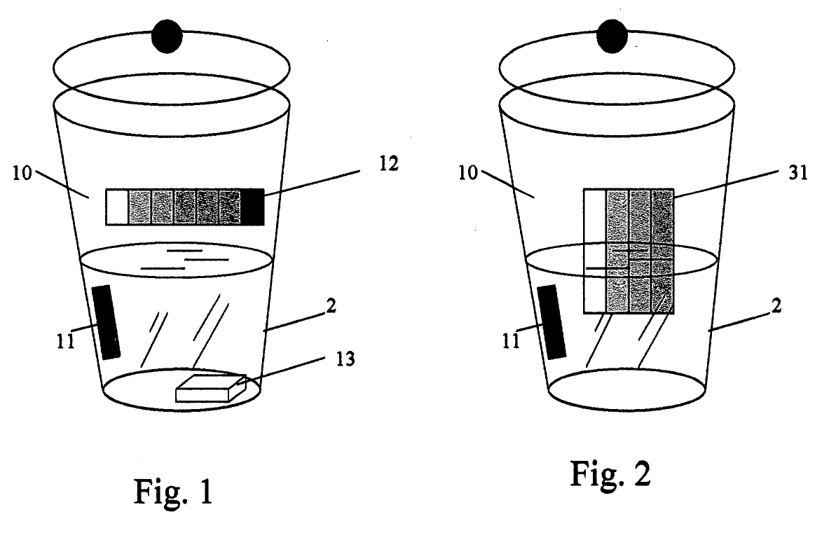

With reference to FIG. 1, the non-electric heated utensil device of the present invention is illustrated. The present invention comprises a non-electric heat utensil body 10 capable of filling with food 2; a temperature sensor 11 for measuring temperatures of the food 2 in the non-electric heat utensil body 10 or temperatures of the non-electric heat utensil body 10; a display device 12 for displaying the temperatures from the temperature sensor 11; and a power supply 13. Moreover, the food 2 is for example, beverage.

In the drawing, the wire connected the display device 12 and the temperature sensor 11 is a circuit from transferring signals therebetween, however if wireless transmission is used, the wire can be neglected.

In the present invention, the non-electric heat utensil body 10 is one of a cup, a bowl, a bottle, a kettle, and a basin.

In the present invention, the power supply 13 may be a battery, for example, a solar battery.

In the present invention, the temperature sensor 11 is one of a chemical temperature sensor, a mechanical temperature sensor 11, a physical temperature sensor, and an electronic temperature sensor. The temperature sensor 11 is installed within the non-electric heat utensil body 10 for measuring the temperature 11 of the food 2 or installed at an outer side of the temperature sensor 11 for measuring the temperature of the non-electric heat utensil body 10.

In FIG. 2, it is illustrated that a chemical temperature sensor is realized as a chemical temperature sensing paper which presents various colors due to temperatures. The temperature sensor 11 is displayed by the color of the sensing paper. Thereby no power supply is necessary.

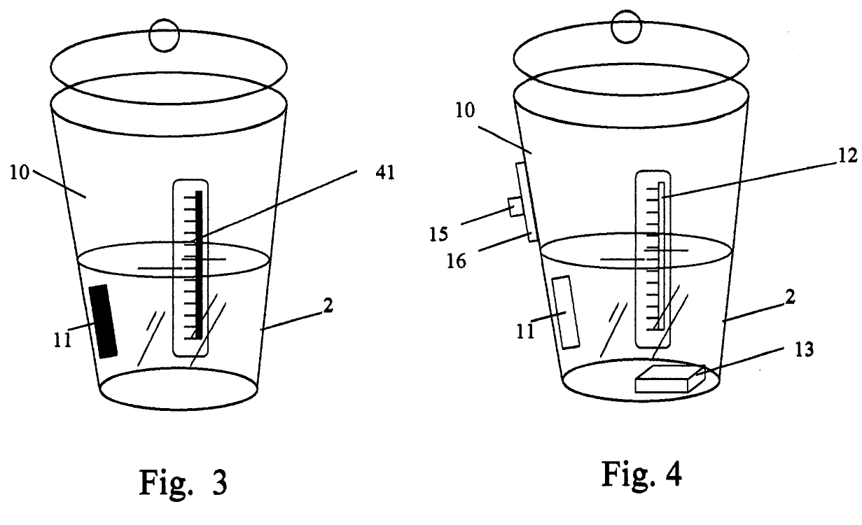

Referring to FIG. 3, a physical temperature sensor 11 is illustrated, in that the temperature sensor 11 is a conventional mercury thermometer 41.

Moreover, in the present invention, the display device 12 displays the temperature by numbers, colors, light intensities, light colors, sounds, or other indications, or the combination of above mentioned objects.

In the embodiment of the present invention, when color or light color is used to display temperature value. The temperatures can be displayed by various different colors, or a single color with different gray levels, such as use black color to represent high temperature, white color to represent low temperature; and colors of different gray levels between black and white are used to represent temperatures between the low temperature and high temperature. In another embodiment, the cool colors, such as white, blue, are used to represent low temperatures and warm colors, such as red color, are used to represent high temperatures.

In the present invention, the temperatures can be represented by lights of different colors. However the temperature can also be represented by lights of different intensities.

In the present invention, when sound is used to represent temperatures, a button 15, see FIG. 4, is installed. A speech integrated circuit 16 is used as a processor for emitting a sound to inform the temperature values to users. However this way can be used with other ways.

In one embodiment of the present invention, the non-electric heat utensil body 10 has a cover 16 and the display device 12 is installed on the cover 16. Thereby the users can see the temperature value easily and conveniently.

In a further embodiment of the present invention, the display device 12 has an alarm for informing users that the temperature is not within an acceptable range. The alarm may be emitted by sound or light.

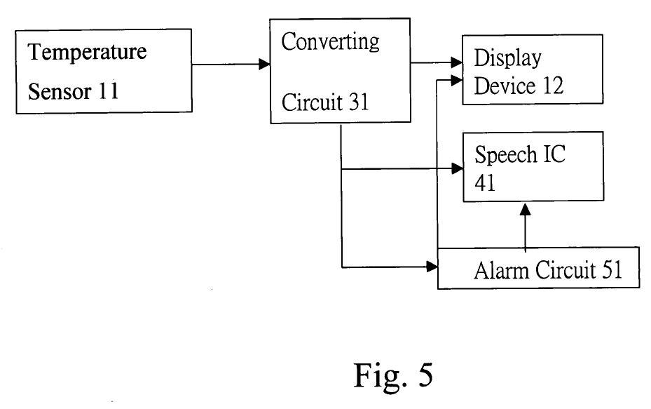

The circuit arrangement of the present invention is illustrated in FIG. 5. The temperature sensor 11 serves to measure a temperature and then transfer the temperature value to a converter 31. The converter 31 converts the temperature value to a light signal, a sound signal, a color signal, or a number. Then, the signals are transferred to the display device 12 for being displayed. If a sound display is used, a speech integrated circuit 41 (speech IC) is used to emit sounds. When an alarm function is included in the present invention, an alarm circuit 51 is used for determining whether the temperature is within an acceptable range so as to emit an alarm signal to users. The alarm signals may be sound or light signals. In the present invention, the signal transfer between the elements can be performed by wired or wireless way.

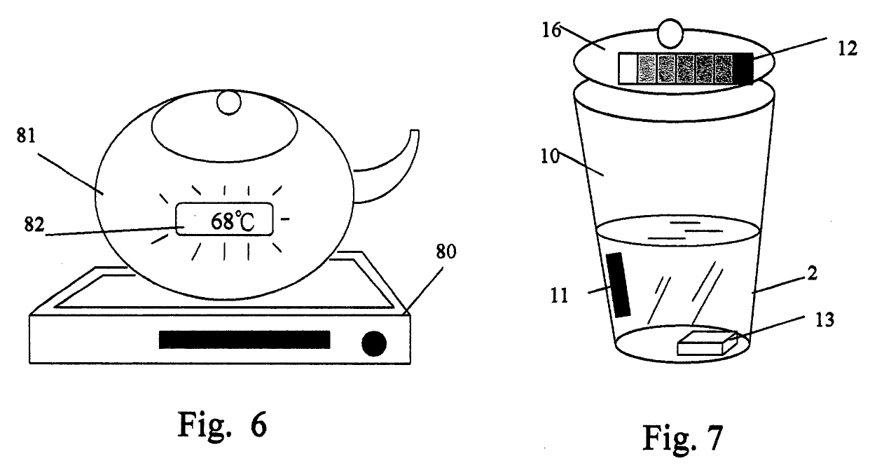

An application of the present invention is illustrated in FIG. 6. In this application, an electromagnetic oven 80 is used to heat a kettle 81. The display device 82 is presented as a face adhered on the surface of the kettle. Thereby when heating the kettle, the temperature of the water in the kettle can be presented to users.

Thus, by the present invention, the user can know the temperature of the food in the non-electric heat utensil body or the temperature of the non-electric heat utensil body. Thereby the user can adapt a proper action or to adjust the temperature of the food or the non-electric heat utensil body.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A non-electric heated utensil device comprising:
a non-electric heat utensil body capable of receiving foods therein so that user can eat the food in the utensil directly;
a temperature sensor for measuring temperatures of the food in the non-electric heat utensil body or temperatures of the non-electric heat utensil body;
a display device for displaying the temperatures from the temperature sensor; and
a power supply.

2. The non-electric heated utensil device as claimed in claim 1, wherein the non-electric heated utensil device is beverage.

3. The non-electric heated utensil device as claimed in claim 1, wherein the non-electric heat utensil body is a cup.

4. The non-electric heated utensil device as claimed in claim 1, wherein the non-electric heat utensil body is one of a bowl, a bottle, a kettle, and a basin.

5. The non-electric heated utensil device as claimed in claim 1, wherein the power supply is a battery.

6. The non-electric heated utensil device as claimed in claim 1, wherein the temperature sensor is one of a chemical temperature sensor, a mechanical temperature sensor, a physical temperature sensor, and an electronic temperature sensor.

7. The non-electric heated utensil device as claimed in claim 1, wherein the temperature sensor is installed within the non-electric heat utensil body for measuring the temperature of the food or installed at an outer side of the temperature sensor for measuring the temperature of the non-electric heat utensil body.

8. The non-electric heated utensil device as claimed in claim 1, wherein the temperature sensor is a chemical temperature testing paper; and the temperature sensor is displayed by different colors of the testing paper.

9. The non-electric heated utensil device as claimed in claim 1, wherein the temperature sensor is a mercury thermometer.

10. The non-electric heated utensil device as claimed in claim 1, wherein the display device displays temperature values by one of numbers, colors, light intensities, light colors, sounds, and indications, and the combination of above mentioned objects.

11. The non-electric heated utensil device as claimed in claim 1, wherein the temperature values is displayed by various different colors.

12. The non-electric heated utensil device as claimed in claim 1, wherein colors of different gray levels are used to represent temperatures between the low temperature and high temperature.

13. The non-electric heated utensil device as claimed in claim 1, wherein cool colors are used to represent low temperatures and warm colors are used to represent high temperatures.

14. The non-electric heated utensil device as claimed in claim 1, wherein a button and a speech integrated circuit are installed in the display device, when the button is pushed, the speech integrated circuit will emit a sound to inform the temperature value.

15. The non-electric heated utensil device as claimed in claim 1, wherein the non-electric heat utensil body has a cover and the display device is installed on the cover.

16. The non-electric heated utensil device as claimed in claim 1, wherein the display device has an alarm for informing users that the temperature is not with an acceptable range and the alarm is one of sound and light signals.

17. The non-electric heated utensil device as claimed in claim 1, further comprising:
a converter for converting a temperature value to a signal which is then transferred to the display device 12 for being displayed;
a speech integrated circuit for emitting sounds; and
an alarm circuit for determining whether the temperature is within an acceptable range so as to emit an alarm signal to users.
